(19) United States
(12) Patent Application Publication
(10) Pub. No.: US 2010/0250298 A1
(43) Pub. Date: Sep. 30, 2010

(54) PRIORITIZATION ENABLEMENT FOR SOA GOVERNANCE

(75) Inventors: Kishore Channabasavaiah, Palatine, IL (US); Pawan Khera, Sewickley, PA (US); Raghu Varadan, San Francisco, CA (US); Nevenko Zunic, Hopewell Junction, NY (US)

Correspondence Address: Driggs, Hogg, Daugherty & Del Zoppo Co., L.P.A., 38500 CHARDON ROAD, DEPT. IEN, WILLOUGHBY HILLS, OH, 44094, US

(73) Assignee: International Business Machines Corporation, Armonk, NY (US)

(21) Appl. No.: 12/410,572

(22) Filed: Mar. 25, 2009

(51) Int. Cl. G06Q 10/00; G06N 5/02

(52) U.S. Cl. 705/7; 706/52

(57) ABSTRACT

Methods, including service methods, articles of manufacture, systems, articles and programmable devices provide a service-oriented architecture prioritization enablement framework. Business objectives and principles indicative of a service-oriented architecture enterprise are defined and categorized with respect to a plurality of business objectives and principles categories, and groupings of individual measurable business goals are categorized with respect to the categories. Total weight values are determined for each business goal as a product of an individual weighting values and base weightings of the categories. The business goal total weight values are iteratively applied priority values of a service of the service-oriented architecture associated with each business goal to generate a weighted priority values, which are aggregated to produce an aggregated priority weighting value for the service used for service prioritization.

### FIELD OF THE INVENTION

The present invention generally describes prioritization enablement within service-oriented architecture.

### BACKGROUND OF THE INVENTION

It is known for organizations to use service-oriented architecture (SOA) methods, systems and governance models to develop and deploy shareable and reusable services which need to evolve over time. SOA governance generally encompasses an entire organization involved in a transformation and requires participation by multiple stakeholders in definition and realization. However, existing information technology (IT) and SOA governance methods have inadequacies and do not drive effective change and service adoption across an enterprise, generally ignoring business domain aspects of SOA governance and management.

FIG. 1 illustrates a prior art model 01 for prioritization of shared services within an SOA, wherein at 02 projects are categorized, for example with respect to business value, mandatory requirements and/or other values. At 04 a balance scorecard is performed based on business value, return-on-investment (ROI), business readiness and/or other values. At 06 line-of-business (LOB) reviews & prioritization is performed with respect to LOB goals, resulting in prioritized LOB portfolios and consolidation at 08 and in a consolidated portfolio scorecard adjustment at 10. Although the prior art model 01 is responsive to service and maturity and comprehensiveness with respect to non-SOA aspects, it addresses prioritization only at program and project levels without addressing organizational governance aspects for SOA, and further fails to address prioritization of services and SOA across an enterprise.

### SUMMARY OF THE INVENTION

Methods provide a service-oriented architecture prioritization enablement framework. Business objectives and principles indicative of a service-oriented architecture enterprise are defined and categorized with respect to a plurality of business objectives and principles categories. Groupings of individual measurable business goals are defined and categorized with respect to each of the business objectives and associated principles categories. Total weight values are determined for each of the business goals as a product of an individual weighting values and base weightings of the business objectives and principles categories. The business goal total weight values are iteratively applied priority values of a service of the service-oriented architecture associated with each business goal to generate a weighted priority values for each business goal for all of the plurality of service priority values. The weighted business goal priority values are aggregated to produce an aggregated priority weighting value for the service, and the service is prioritized relative to another service as a function of comparing aggregated priority weighting values. In one aspect, methods comprise providing a programmable device configured to perform at least one of defining business objectives and principles, categorizing the business objectives and principles, defining groupings of individual measurable business goals, determining total weight values for each of the business goals, applying total weight values to service priority values, aggregating weighted priority values and prioritizing services.

Service methods are also provided comprising deploying programmable devices, logic components or applications for providing a service-oriented architecture prioritization enablement framework according to the method steps described above, for example by a service provider who offers to implement, deploy, and/or perform functions for others. Still further, articles of manufacture comprising a computer usable medium having a computer readable program in said medium are provided. Such program code comprises instructions which, when executed on a computer system, cause the computer system to perform one or more method and/or process elements described above for providing a service-oriented architecture prioritization enablement framework. Moreover, systems, articles and programmable devices are also provided, configured for performing one or more method and/or process elements of the current invention for providing a service-oriented architecture prioritization enablement framework, for example as described above.

### BRIEF DESCRIPTION OF THE DRAWINGS

These and other features of the methods, systems and devices according to the present application will be more readily understood from the following detailed description of the various aspects of the embodiments taken in conjunction with the accompanying drawings in which:

FIG. 1 is a block diagram illustration of a prior art model for prioritization.

FIG. 2 illustrates a model and/or process for providing a service-oriented architecture prioritization enablement framework according to the present invention.

FIG. 3 is a tabular illustration of a prioritization enablement framework according to the present invention.

FIG. 4 is a tabular illustration of a prioritization enablement framework according to the present invention.

FIG. 5 is a tabular illustration of a prioritization enablement framework according to the present invention.

FIG. 6 is a tabular illustration of a prioritization enablement framework according to the present invention.

FIG. 7 is a chart illustration of total integration weight values generated for a plurality of services according to the present invention.

FIG. 8 is a block diagram of a system or device configured to implement a service-oriented architecture prioritization enablement framework according to the present invention.

FIG. 9 is a block diagram illustrating a computerized implementation of a method or system for a service-oriented architecture prioritization enablement framework according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience, the Detailed Description of the Invention has the following sections:

I. General Description; and

II. Computerized Implementation.

### I. General Description

Examples of SOA aspects and governance processes according to the present invention may be found in the following commonly-owned and co-pending U.S. patent applications or issued U.S. patents, the disclosures of which are expressly incorporated herein by reference: “Identifying a Service Oriented Architecture Shared Services Project”, attorney docket no. END920080252US1, filed on (to be provided), and assigned application Ser. No. (to be provided); “Evaluating a Service Oriented Architecture Shared Services Project”, attorney docket no. END920080288US1, filed on (to be provided), and assigned application Ser. No. (to be provided); “Service Oriented Architecture Shared Service Inception”, attorney docket no. END920080289US1, filed on (to be provided), and assigned application Ser. No. (to be provided); “Service Oriented Architecture Shared Services Elaboration”, attorney docket no. END920080290US1, filed on (to be provided), and assigned application Ser. No. (to be provided); “Service Oriented Architecture Shared Services Construction”, attorney docket no. END920080291US1, filed on (to be provided), and assigned application Ser. No. (to be provided); “Transitioning to Management of a Service Oriented Architecture Shared Service”, attorney docket no. END920080292US1, filed on (to be provided), and assigned application Ser. No. (to be provided); “Service Oriented Architecture Shared Service Management”, attorney docket no. END920080293US1, filed on (to be provided), and assigned application Ser. No. (to be provided); “Service Oriented Architecture Shared Service Escalation”, attorney docket no. END920080294US1, filed on (to be provided), and was assigned application Ser. No. (to be provided); “SOA Policy Versioning”, attorney docket no. END920080316US-IEN106616, filed on (to be provided), and assigned application Ser. No. (to be provided); “FRAMEWORK FOR VARIATION ORIENTED ANALYSIS FOR SERVICE-ORIENTED ARCHITECTURE”, attorney docket no. END920080317US1-IEN106617, filed on (to be provided), and assigned application Ser. No. (to be provided); “TECHNICAL FEASIBILITY EXPLORATION FOR SERVICE-ORIENTED ARCHITECTURE ENVIRONMENTS”, attorney docket no. END920080318US1-IEN106618, filed on (to be provided), and assigned application Ser. No. (to be provided); “SOA Lifecycle Governance and Management”, attorney docket no. END920080319US1-IEN106619, filed on (to be provided), and assigned application Ser. No. (to be provided); “ENABLING SOA GOVERNANCE USING A SERVICE LIFECYCLE APPROACH”, attorney docket no. END920080320US1-IEN106620, filed on (to be provided), and assigned application Ser. No. (to be provided); “CALIBRATION FRAMEWORK FOR EFFORT ESTIMATION”, attorney docket no. END920080321-IEN106621, filed on (to be provided), and assigned application Ser. No. (to be provided); “SERVICE PORTFOLIO APPROACH FOR SOA GOVERNANCE”, attorney docket no. END920080386US1-IEN106642, filed on (to be provided), and assigned application Ser. No. (to be provided); “SERVICE EVOLUTION APPROACH IN SOA”, attorney docket no. END920080387US1-IEN106643, filed on (to be provided), and assigned application Ser. No. (to be provided); “CAPABILITY AND MATURITY-BASED SOA GOVERNANCE”, attorney docket no. END920080388US1-IEN106644, filed on (to be provided), and assigned application serial no. (to be provided); and “SOA POLICY ENGINE FRAMEWORK”, attorney docket no. END920080390US1-IEN106646, filed on (to be provided), and assigned application Ser. No. (to be provided).

SOA governance may be understood to encompass an entire organization involved in a transformation and should require participation by multiple stakeholders in definition and realization. A well-defined governance framework and underlying model helps to drive effective change across an enterprise, and may be a key to success irrespective of an entry point chosen by an enterprise for an SOA transformation. Additionally, an effective SOA governance model may be realized by establishing a governance body comprising domain owners and stakeholders with delegated responsibility for decision making.

One impact of a move toward services orientation is a business units' (BU) consideration of an ‘enterprise perspective’ while making decisions and planning for shared services, rather than solely through their own BU perspective. It is desired for BU's to thus consider interdependencies with other units and any needs to depend on other units for some services needed, and further wherein each BU should deemphasize local optimization in favor of global, enterprise-wide optimization with respect to utilizing shared services.

FIG. 2 illustrates a model and/or process 11 for providing a service-oriented architecture prioritization enablement framework. At 12 business objectives and principles indicative of a service-oriented architecture enterprise are defined and categorized with respect to a one or more business objectives and principles categories. At 14 groupings of individual measurable business goals of the business objectives and principles are defined and categorized with respect to each of the business objectives and principles categories. At 16 total weight values are determined for each of the business goals as a product of an individual weighting value of each business goal and a base weighting of the business objectives and principles category of the business goal. At 18 the total weight values of each of the business goals are applied to priority values of a service of the service-oriented architecture associated with each business goal, thereby generating weighted priority values associated with each of the business goals for the service. At 20 the weighted of the business goal priority values are aggregated to produce an aggregated priority weighting value for the service. At 22 the service is prioritized relative to another service as a function of comparing the aggregated priority weighting value for the service to a total priority weighting value for the other service.

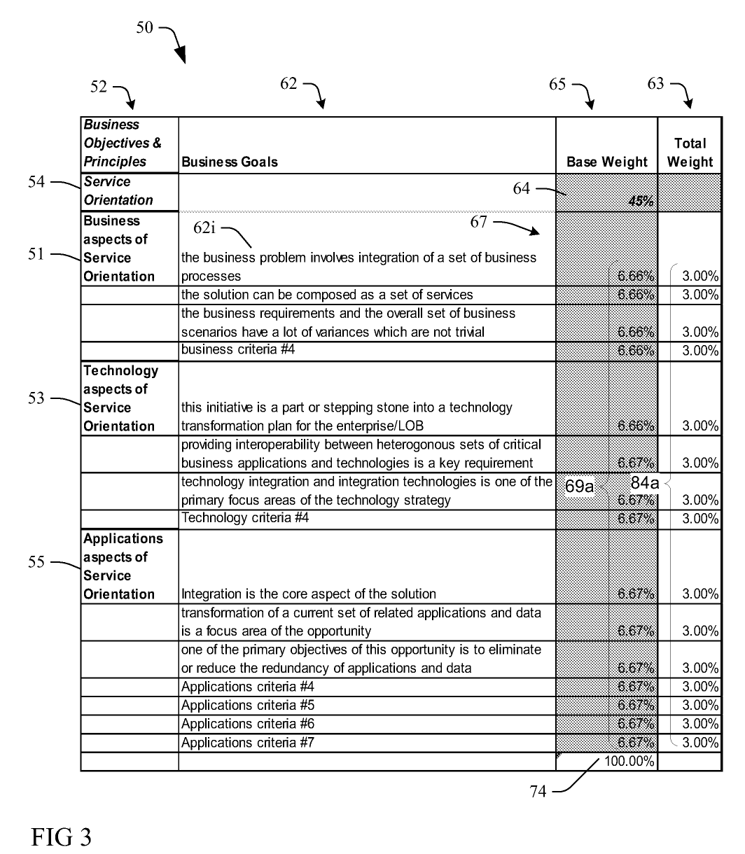

FIGS. 3, 4, 5 and 6 illustrate portions of an overall SOA prioritization enablement framework or template 50 configured according to the present invention. The framework 50 and associated processes may be realized as a unique business tool or as part of a business tooling portfolio. In one aspect the framework 50 identifies scorecard criteria from different business and SOA principles 52, integrating SOA aspects along with the traditional business objectives and goals model into a unique prioritization model to enable SOA planning and governance at a business level and providing a framework to evaluate any given business or SOA initiative. Embodiments of the present invention may also use SOA opportunity identification criteria, and more particularly from frameworks for identifying service oriented opportunities during portfolio planning phase as integrated with an enterprise's business objectives and goals, as discussed in one or more of the above previously incorporated references.

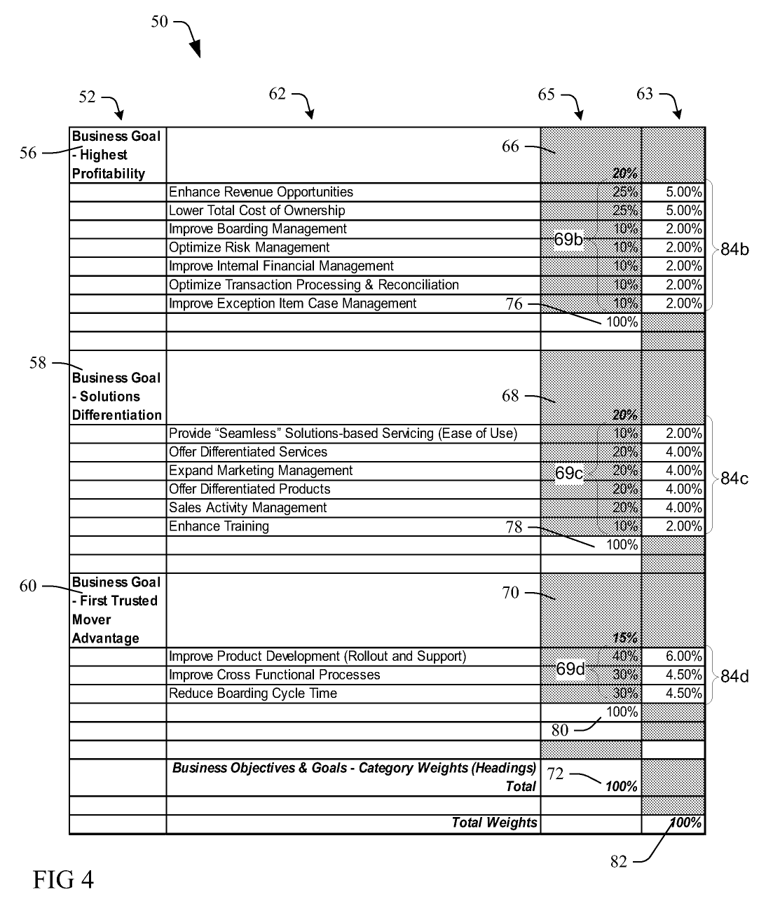

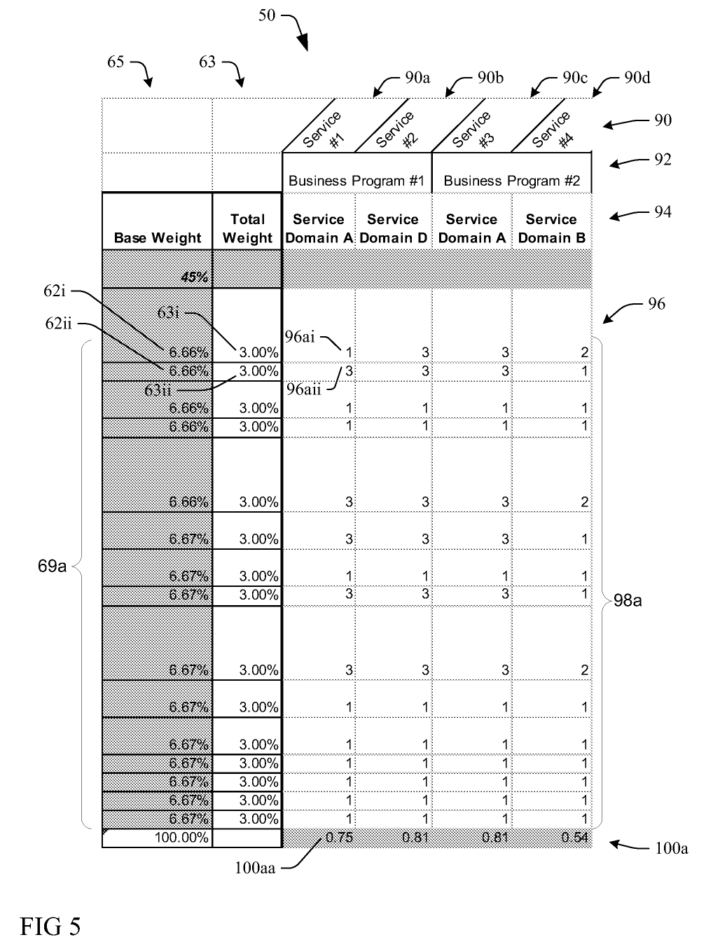

In the embodiment of FIGS. 3 and 4, a plurality of business objectives and principles elements 52 are defined indicative of an SOA enterprise, in some embodiments a combination of both SOA and business-specific objectives and principles. The business objectives and principles elements 52 are defined with respect to a plurality of categories and or sub-categories: the present example 50 provides for four categories (Service Orientation 54, Business Goal—Highest Profitability 56, Business Goal—Solutions Differentiation 58 and Business Goal—First Trusted Mover Advantage 60), wherein the Service Orientation 54 category is further defined with respect to a set of aspect sub-categories (Business aspects of Service Orientation 51, Technology aspects of Service Orientation 53 and Applications aspects of Service Orientation 55). Each of the business objectives and principles categories 54/56/58/60 and sub-categories 51/53/55 is further defined with respect to groups of individual measurable business goals 62.

Base weightings 65 are provided and balanced and distributed throughout each of the business goal 62 in a multiple level process, producing a total weight value 63 for each of the business goals 62. At a first level, the broadest categories for scoring each of the business objectives and principles are provided by the categories 54/56/58/60, which each receive a first level base weighting assignment of “45%” 64, “20%” 66 “20%” 68 and “15%” 70, respectively, representing a total distribution of possible base weightings as indicated by a total value 72 of the category base weighting of 100%. At a second level, individual intra-category base weighting distribution values 67 are apportioned and to each of the business goals 62 as a function of business objectives and principles category 54/56/58/60 business goal groupings 69a, 69b, 69c and 69d, respectively, wherein totals of the intra-category base weighting distribution values 67 within each category 54/56/58/60 grouping 69a, 69b, 69c and 69d also each define a total intra-category base weighting distribution value 74, 76, 78 and 80, respectively, of 100%.

In some embodiments, the category base weightings 64/66/68/70 and/or the individual intra-category base weightings 67 may be populated with initial default values as an organization initiates the usage of the present framework 50, which may be adjusted by a user over time as an organization matures and gathers historical data for use in fine-tuning the template 50 and application thereof. For example, initial default values may be adjusted as a function of comparing current organization observation data to historical organization observation data.

At a third distribution level, each of the business goals 62 is then assigned a total weight value 63 as a function of its individual intra-category base weighting distribution value 67 and the base weighting 64, 66, 68 or 70 of its category 54/56/58/60. Accordingly, each category grouping of total weight values 84a, 84b, 84c and 84d have a total value equal to their respective category base weight values 64, 66, 68 and 70, respectively, and a total value 82 of all of the distributed business goal 62 total weight values 63 equals 100%, thus reflecting a first, second and third level-generated total and complete distribution of all possible weighting percentage values throughout all of the defined business goals 62.

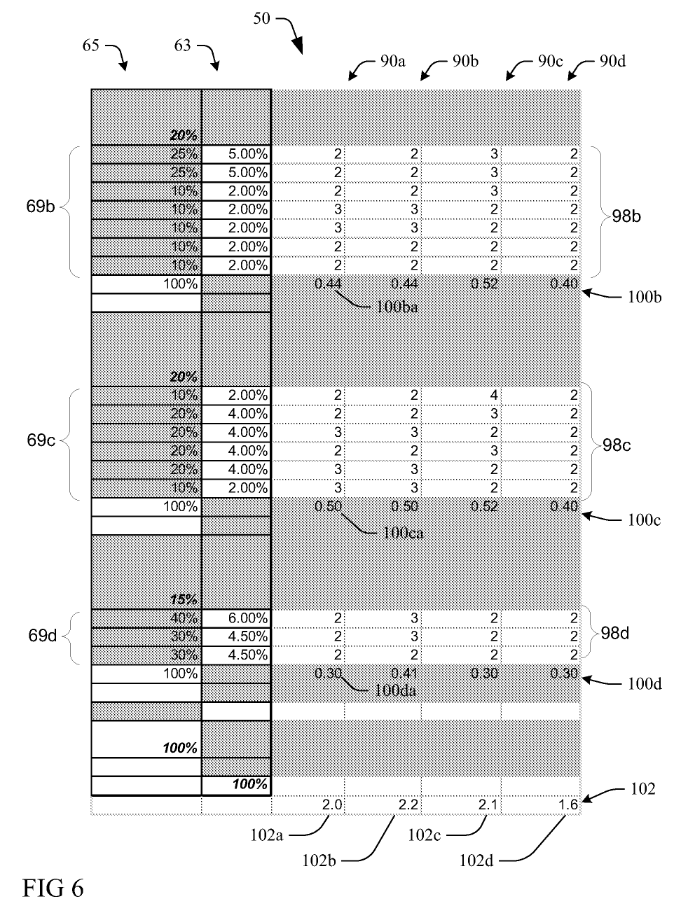

FIGS. 5 and 6 illustrate an exemplary application of the template 50 total weight values 63 to prioritization of each of a plurality of services 90 of a plurality of business programs 92, wherein each service 90 may also be defined with respect to one of a plurality of specific enterprise domains 94. A service 90 may be understood to refer to a business or data service serving as a reusable component within an SOA, and may contemplate a range of functionality, illustratively but not exhaustively including data access, data aggregation and transformation, and data update services. SOA services generally improve efficiency and productivity through reuse as well as through a higher level of programming abstraction relative to non-SOA services. A business program 92 comprises a plurality of services 90 and defines a discrete business project which may be created, implemented or modified on a business-project level. A domain 94 refers to a model that categorizes the services 90 with respect to the relationship of discrete attributes of each service 90; for example, unique attributes or associated entities of each of the services 90a and 90c, though not necessarily shared, may nonetheless define (or be defined by) a virtual body or domain “Service Domain A” 94a within an SOA enterprise, distinguished from another virtual body/domain “Service Domain B” 94ab within said SOA enterprise. Other meanings and implications of the SOA terms such as domain, service and business program will also be apparent to one skilled in the art.

The model 50 extends foundational criteria set and provides the mechanisms to identify the business services 90, corresponding business programs 92 and their respective alignment to their business services domains 94. The construct 50 provides flexibility and allows an analytical approach to determine cross-business unit business services leverage. In one aspect, identifying each of the various business services 90 and the business services domains 94 as provided in the framework 50 may be accomplished through application of a Business Model Driven Interactive Platform for Service Identification model described in one or more of the above incorporated references, through an interactive platform design used to identify business process 90 overlaps, business domain 94 and process 90 classification, program 92 dependency, etc., which helps to arrive at a business unit accountability matrix wherein priority “balance” is captured as prioritization ratings 96.

More particularly, in the present example, each of the services 90 are rated for integration with respect to each of the business goals 62 on a 1-to-3 scale, with 1 representing “very little integration,” 2 representing “average integration” and 3 representing “very high integration,” resulting in populating the template 50 with a plurality of individual ratings 96 for each business goal 62. Other scales may be used as well, including 1-to-5 and 1-to-10 scales as well as non-integer or continuous rating value systems, and the present invention is not limited to the exemplary embodiments described herein. Each rating 96 may be captured from multiple stakeholders and aggregated as an average to arrive at a consensus of prioritization, or it may also be accomplished using one single output from one single stakeholder representing an overall organization for SOA prioritization. The ratings 96 are clustered in groupings 98a, 98b, 98c and 98d corresponding to the respective business goal groupings 69a, 69b, 69c and 69d for each of the services 90, and at a fourth level of a prioritization process according to the present invention each of the integration ratings 96 are weighted by application of their respective total weight values 63 and as weighted then aggregated into weighted category rating values 100a, 100b, 100c and 100d for each of the respective business goal groupings 69a, 69b, 69c and 69d, which are then added together to produce total integration weight values 102 for each of the services 90.

For example, the Service No. 1 90a is assigned an integration rating value 96ai of 1 (FIG. 5) for the first business goal 62i (FIG. 3), which is weighted by multiplication with the total weight value 63i of 3.00% of said business goal 62i, and this weighted value added to the second business goal 62ii (FIG. 3) integration rating value 96aii “3” for the service 90a as weighted through multiplication with its corresponding business goal 62ii total weight value 63ii of 3.00%, and this process repeated to add weighted values for each of the remainder of the first business goal grouping 69a integration ratings 98a for the Service No. 1 90a to produce an aggregate weighted category integration rating value 100aa of “0.75” for the business goal grouping 69a/integration rating grouping 98a.

This process is repeated for each of the other integration ratings 96 of the business goal category groupings 69b, 69c and 69d and respective integration rating groupings 98b, 98c and 98d for the Service No. 1 90a, producing an aggregate weighted category integration rating value 100ba of “0.44” for the business goal grouping 69b/integration rating grouping 98b, an aggregate weighted category integration rating value 100ca of “0.50” for the business goal grouping 69c/integration rating grouping 98c, and an aggregate weighted category integration rating value 100da of “0.30” for the business goal grouping 69d/integration rating grouping 98d. The aggregate weighted category integration rating values 100aa, 100ba, 100ca and 100da are then added together to produce a total integration weight value 102a for the Service No. 1 90a of “2.0.” These process are further repeated for each of the reminding service 90b, 90c and 90d, resulting in the production of total integration weight values “2.2” 102b for the Service No. 2 90b, “2.1” 102c for the Service No. 3 90c, and “1.6” 102d for the Service No. 4 90d.

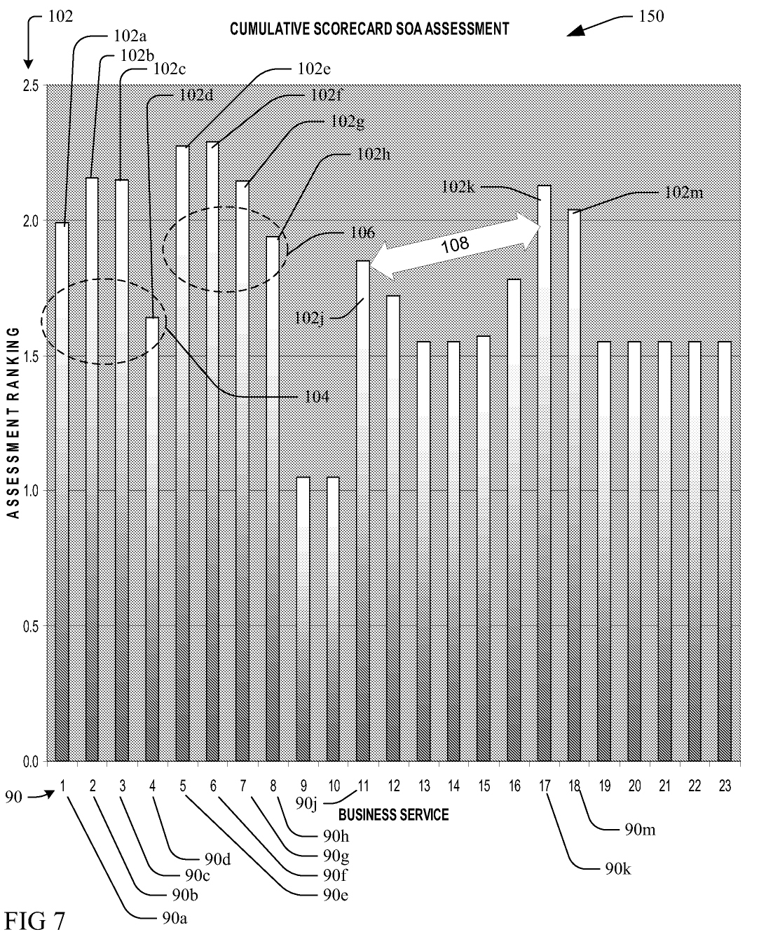

FIG. 7 provides a chart illustration 150 plotting the each of the total integration weight values 102a, 102b, 102c and 102d of FIGS. 3 through 6, as well as total integration weight values 102 of other services 90 determined according to the present invention as described above. Plotting and/or other comparisons of the total integration weight values 102 as provided in FIG. 7 may provide a variety of prioritization functions according to the present invention. For example, the first four service 90 total integration weight values 102a, 102b, 102c and 102d may be considered as a core analytic group 104 and reviewed/processed to determine core business data analytics and information delivery initiates data. Another grouping 106 of service 90e, 90f, 90g and 90h may define a service and/or sales initiates service grouping 106 of total integration weight values 102e, 102f, 102g and 102h. The total integration weight values 102j and 102k of Services 90j and 90k, respectively, may be considered in a cross-business collaboration and customer care comparison 108, in some examples across divergent respective business programs 92 and/or domains 94. In still another example, the total integration weight value 102m of a service 90m may represent the priority of a customer boarding initiative.

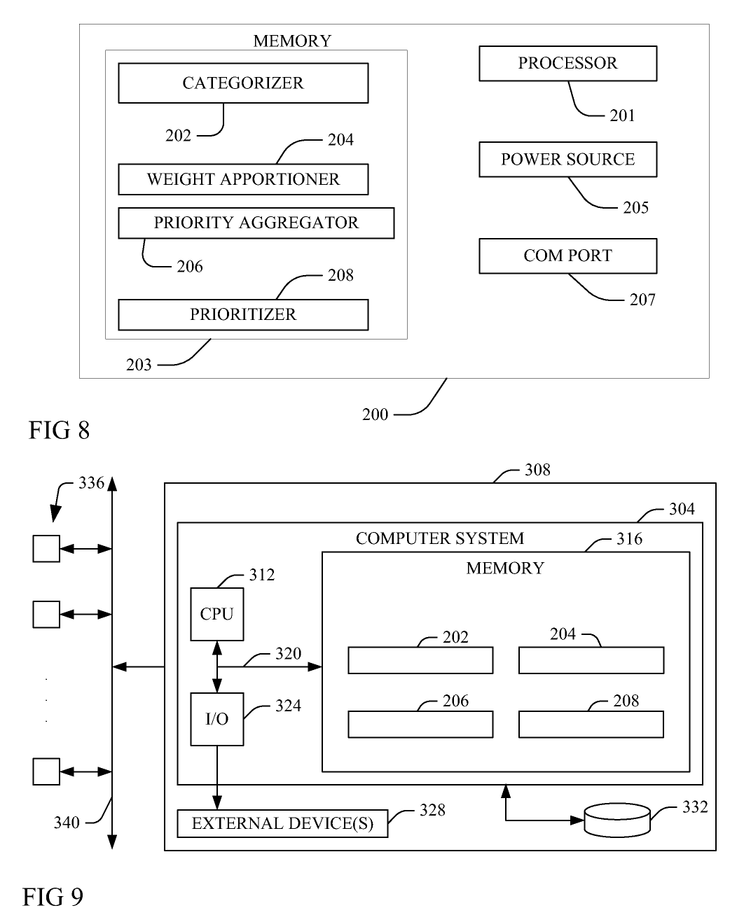

FIG. 8 illustrates a programmable device or module 200 configured to implement a SOA prioritization enablement framework (/service evolution governance model) for a service-oriented architecture according to the present invention, for example as illustrated in FIGS. 2 through 7 and described above. The device 200 may be incorporated into a larger system (such as one provided by a service provider) wherein other applications and components of the larger system accomplish systems and methods according to the present invention, or it may be a stand-alone device or module 200 configured to perform each of the systems and methods described above. The present embodiment thus comprises a central processing unit (CPU) or other processing means 201 in communication with a memory 203 comprising logic components that enable the CPU 201 to perform processes and methods according to the present application, as will be understood through reference to FIGS. 2 through 7 as discussed above. Thus, the memory 203 comprises an Categorizer logic component 202 configured to defining and/or categorize business objectives and principles with respect to categories and/or define groupings of individual measurable business goals categorized with respect to the categories; a Weight Apportioner logic component 204 configured to apportioning category base and/or individual intra-category business goal weighting percentage values; a Priority Aggregator logic component 206 configured to determine aggregated weighted priority values for a service as a function of priority values and the category base and/or individual intra-category business goal weighting percentage values; and a Prioritizer logic component 208 configured to prioritizing services as a function of comparing the aggregated weighted priority values.

A power source 205 is configured to provide operative power to the device 200; examples include battery units 205 and power inputs configured to receive alternating or direct current electrical power, and other appropriate power units 205 will be apparent to one skilled in the art. A communication port or network link/node means (“com port”) 207 is also provided and configured to enable data and other communications as may be appropriate, for example as discussed above.

One aspect of promoting shared services through SOA in organizations is to plan and define the transformation needs through prioritizing SOA initiatives. This includes all supporting roles and processes to meet the growing business requirements. The present invention (for example embodiments illustrated in FIGS. 2-9 and discussed herein) provides an SOA prioritization enablement framework and approach which addresses issues of management, process ownership, accountability and responsibility which should be balanced in the context of SOA adoption. More particularly, the prioritization enablement framework 50 identifies a need for metrics to support the adoption and to promote the effectiveness of this paradigm shift in the development of business solutions using SOA.

Specifically, as organizations mature towards a shared services environment through adoption of SOA, organization-wide impacts may include: planning and governance of services in early stages of a business lifecycle; more interaction between IT divisions and business units to help align individual business goals and objectives through prioritization; usage of a common shared services infrastructure based on individual business unit and enterprise prioritization; and evolution in the prioritization of common resource pools in a shared services world. Each of these organization-wide impacts may necessitate planning and governance to address prioritization of SOA initiatives and corresponding services, which should facilitate the collaboration of the various business units and also the concerned IT units, and can further help staff plan and determine capacity while at the same time filling a necessary gap of facilitating complex issues around funding and ownership of shared services in an SOA.

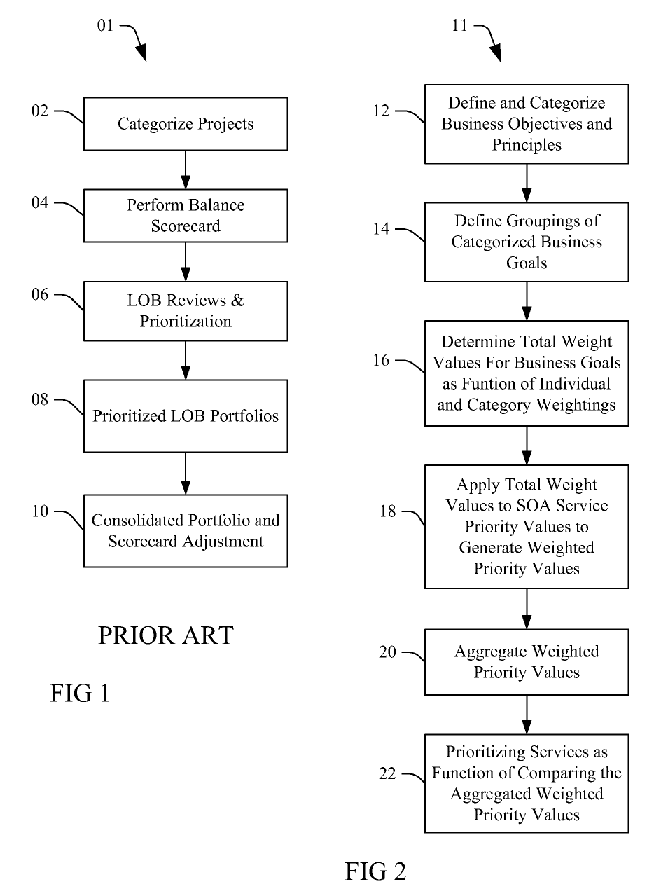

Prior art models and frameworks adopted by various organizations (for example the prior art model 01 of FIG. 1), though they may show maturity and comprehensiveness aspects, may address prioritization only at a program and/or project level without addressing organizational governance aspects for SOA. Such prior art models do not address prioritization of services and/or an SOA across an enterprise, offering instead an ability to balance initiatives and prioritize within the influences of the enterprise/business unit goals and objectives but without offering any mechanism to identify and apply cross-business process dependencies in the process of a prioritization approach (for example as illustrated in FIG. 7 and discussed above). Neither do the prior art methods allow a way to identify service-oriented opportunities that fall under an SOA approach of provide guidance in enabling related SOA funding and SOA ownership and SOA governance issues.

In contrast, the SOA prioritization enablement framework 50 according to the present invention and described above contains unique elements not taught by the prior art, illustratively but not exhaustively including: providing a framework 50 (as well as supporting models as described in one or more of the related references incorporated above) to enable SOA program prioritization; providing a prescriptive process that can be adopted using the supporting models; providing a framework-driven approach that can be adopted as an independent organizational governance capability; providing leveraging which may be integrated seamlessly into existing organizational governance processes; providing capability for integrating business services capability redundancy elimination in an overall process of prioritization; providing a framework 50 (as well as supporting models as described in one or more of the related references incorporated above) that enables execution in a collaborative environment as well as by an individual, and thus which can also be applied at a business unit level as well as at a cross-business unit-enterprise level along, with a focus on an overall eco-system; and providing an end-to-end framework 50 that enables SOA program/project prioritization while taking into account both cross-business domains of services and an individual set of SOA services.

The framework 50 may used in a multi-step process in a stand-alone prioritization capability, or it may be seamlessly integrated into an enterprise's organizational governance processes. In some examples, a multi-step process includes establishing business value criteria and assigning base weights; identifying service-oriented opportunities through a goals and objectives analysis in a business value analysis prioritization model; classifying programs through foundational, interlocked and critical business impact aspects; performing business domain and process classification through a program dependency-business unit accountability matrix and priority balancing; performing business process and business services dependency analysis; and performing program and business services scoring through a balanced scorecard.

### II. Computerized Implementation

Referring now to FIG. 9, an exemplary computerized implementation of a business services portfolio-centric SOA governance framework according to the present invention includes a computer system 304 deployed within a computer infrastructure 308 such as a computer or a programmable device such as a personal digital assistant (PDA) or cellular phone. This is intended to demonstrate, among other things, that the present invention could be implemented within a network environment 340 (e.g., the Internet, a wide area network (WAN), a local area network (LAN), a virtual private network (VPN), etc.) in communication with one or more additional computers 336, or on a stand-alone computer infrastructure 308. In the case of the former, communication throughout the network 340 can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet.

As shown, the computer system 304 includes a central processing unit (CPU) 312, a memory 316, a bus 320, and input/output (I/O) interfaces 324. Further, the computer system 304 is shown in communication with external I/O devices/resources 328 and storage systems 332. In general, the processing unit 312 executes computer program code, such as the code to implement various components of the process and systems, and devices as illustrated in FIGS. 2 through 8 and described above, including the Categorizer logic component 202, the Weight Apportioner logic component 204, the Priority Aggregator logic component 206 and the Prioritizer logic component 208, and which are stored in memory 316 and/or storage system 332. It is to be appreciated that two or more, including all, of these components may be implemented as a single component.

While executing computer program code, the processing unit 312 can read and/or write data to/from the memory 316, the storage system 332 (e.g. the, and/or the I/O interfaces 324. The bus 320 provides a communication link between each of the components in computer system 304. The external devices 328 can comprise any devices (e.g., keyboards, pointing devices, displays, etc.) that enable a user to interact with computer system 304 and/or any devices (e.g., network card, modem, etc.) that enable computer system 304 to communicate with one or more other computing devices.

The computer infrastructure 308 is only illustrative of various types of computer infrastructures for implementing the invention. For example, in one embodiment, computer infrastructure 308 comprises two or more computing devices (e.g., a server cluster) that communicate over a network to perform the various process steps of the invention. Moreover, computer system 304 is only representative of various possible computer systems that can include numerous combinations of hardware.

To this extent, in other embodiments, the computer system 304 can comprise any specific purpose-computing article of manufacture comprising hardware and/or computer program code for performing specific functions, any computing article of manufacture that comprises a combination of specific purpose and general-purpose hardware/software, or the like. In each case, the program code and hardware can be created using standard programming and engineering techniques, respectively. Moreover, the processing unit 312 may comprise a single processing unit, or be distributed across one or more processing units in one or more locations, e.g., on a client and server. Similarly, the memory 316 and/or the storage system 332 can comprise any combination of various types of data storage and/or transmission media that reside at one or more physical locations.

Further, I/O interfaces 324 can comprise any system for exchanging information with one or more of the external device 328. Still further, it is understood that one or more additional components (e.g., system software, math co-processing unit, etc.) not shown in FIG. 9 can be included in computer system 304. However, if computer system 304 comprises a handheld device or the like, it is understood that one or more of the external devices 328 (e.g., a display) and/or the storage system 332 could be contained within computer system 304, not externally as shown.

The storage system 332 can be any type of system (e.g., a database) capable of providing storage for information under the present invention. To this extent, the storage system 332 could include one or more storage devices, such as a magnetic disk drive or an optical disk drive. In another embodiment, the storage system 332 includes data distributed across, for example, a local area network (LAN), wide area network (WAN) or a storage area network (SAN) (not shown). In addition, although not shown, additional components, such as cache memory, communication systems, system software, etc., may be incorporated into computer system 304.

While shown and described herein as a method and a system, it is understood that the invention further provides various alternative embodiments. For example, in one embodiment, the invention provides a computer-readable/useable medium that includes computer program code to enable a computer infrastructure to implement methods, systems and devices according to the present application, for example as illustrated in FIGS. 2 through 9 described above and otherwise herein. To this extent, the computer-readable/useable medium includes program code that implements each of the various process steps of the present application.

It is understood that the terms “computer-readable medium” or “computer useable medium” comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 316 and/or the storage system 332 (e.g., a fixed disk, a read-only memory, a random access memory, a cache memory, etc.), and/or as a data signal (e.g., a propagated signal) traveling over a network (e.g., during a wired/wireless electronic distribution of the program code).

Still yet, computer infrastructure 308 is intended to demonstrate that some or all of the components of implementation according to the present application could be deployed, managed, serviced, etc. by a service provider who offers to implement, deploy, and/or perform the functions of the present invention for others, for example by licensing methods and browser or application server technology to an internet service provider (ISP) or a cellular telephone provider. In one embodiment, the invention may comprise a business method that performs the process steps of the invention on a subscription, advertising, and/or fee basis. Thus, a service provider can create, maintain, support, etc., a computer infrastructure, such as the computer infrastructure 308 that performs the process steps of the present application for one or more customers, and in return the service provider can receive payment from the customer(s) under a subscription and/or fee agreement and/or the service provider can receive payment from the sale of advertising content to one or more third parties.

In still another embodiment, the invention provides a computer-implemented method for enabling the processes, methods and devices according to the present application. In this case, a computer infrastructure, such as computer infrastructure 308, can be provided and one or more systems for performing the process steps of the invention can be obtained (e.g., created, purchased, used, modified, etc.) and deployed to the computer infrastructure. To this extent, the deployment of a system can comprise one or more of: (1) installing program code on a computing device, such as computer system 304, from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Certain examples and elements described in the present specification, including in the claims and as illustrated in the Figures, may be distinguished or otherwise identified from others by unique adjectives (e.g. a “first” element distinguished from another “second” or “third” of a plurality of elements, a “primary” distinguished from a “secondary,” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method for providing a service-oriented architecture prioritization enablement framework, comprising:
providing a programmable device configured by a logic component;
defining a plurality of business objectives and principles indicative of a service-oriented architecture enterprise;
categorizing the plurality of business objectives and principles with respect to a plurality of business objectives and principles categories;
defining groupings of individual measurable business goals of the business objectives and principles categorized with respect to each of the plurality of business objectives and principles categories;
determining total weight values for each of the business goals as a product of an individual weighting value of the each business goal and a base weighting of the business objectives and principles category of the each business goal;
iteratively applying each of the business goal total weight values to each of a plurality of priority values of a service of the service-oriented architecture associated with the business goal of the each business goal total weight value to generate a weighted priority value for the each business goal until weighted priority values are generated for all of the plurality of service priority values;
aggregating the weighted business goal priority values to produce an aggregated priority weighting value for the service; and
prioritizing the service relative to another service as a function of comparing the aggregated priority weighting value for the service to an aggregated priority weighting value for the another service;
wherein the programmable device is configured to perform at least one of the defining the business objectives and principles, the categorizing the plurality of business objectives and principles, the defining the groupings of individual measurable business goals, the determining the total weight values for each of the business goals, the applying the each of the total weight values to the priority values of the service, the aggregating the weighted priority values and the prioritizing the service.

2. The method of claim 1 wherein the determining the total weight values for each of the business goals comprises:
apportioning category base weighting percentage values to each of the plurality of business objectives and principles categories;
apportioning individual intra-category weighting distribution values to each of the business goals as a function of the business objectives and principles categories; and
determining the total weight value for each of the business goals as a product of the individual intra-category weighting distribution value of the each business goal and the category base weighting of the business objectives and principles category of the each business goal.

3. The method of claim 2 further comprising:
the apportioning the category base weighting percentage values further comprising apportioning each of a set of category base weighting percentage values totaling 100% in value; and
the apportioning the individual intra-category weighting distribution values further comprising apportioning each of a set of individual intra-category base weighting distribution values totaling 100% in value;
wherein a total of all of the total weight values equals 100%.

4. The method of claim 3, further comprising:
categorizing the service with respect to one of a plurality of business programs; and
categorizing the service with respect to one of a plurality of specific enterprise domains as a function of an aspect of the service;
wherein the prioritizing the service relative to the another service is a function of the categorized business program and the categorized domain of the service and of a categorized business program and a categorized domain of the another service.

5. The method of claim 4, further comprising:
populating the each priority value of the service associated with the each business goal by selecting an integer value from a scale of values.

6. The method of claim 5, further comprising:
populating the each priority value with an initial default value; and
adjusting the initial default value as a function of comparing current organization observation data to historical organization observation data.

7. The method of claim 1, further comprising a service provider deploying at least one of the programmable device and the logic component.

8. The method of claim 7, wherein the programmable device is further configured to determine the total weight values for each of the business goals by:
apportioning category base weighting percentage values to each of the plurality of business objectives and principles categories;
apportioning individual intra-category weighting distribution values to each of the business goals as a function of the business objectives and principles categories; and
determining the total weight value for each of the business goals as a product of the individual intra-category weighting distribution value of the each business goal and the category base weighting of the business objectives and principles category of the each business goal.

9. The method of claim 8, wherein the programmable device is further configured to:
apportion the category base weighting percentage values by apportioning each of a set of category base weighting percentage values totaling 100% in value; and
apportion the individual intra-category weighting distribution values by apportioning each of a set of individual intra-category base weighting distribution values totaling 100% in value;
wherein a total of all of the total weight values equals 100%.

10. The method of claim 9, wherein the programmable device is further configured to:
categorize the service with respect to one of a plurality of business programs;
categorize the service with respect to one of a plurality of specific enterprise domains as a function of an aspect of the service; and
prioritize the service relative to the another service is a function of the categorized business program and the categorized domain of the service and of a categorized business program and a categorized domain of the another service.

11. The method of claim 10, wherein the programmable device is further configured to
populate the each priority value of the service associated with the each business goal with an initial default value selected from an integer value from a scale of values; and
adjust the initial default value as a function of comparing current organization observation data to historical organization observation data.

12. A method for providing a service-oriented architecture prioritization enablement framework, comprising:
producing computer executable program code;
storing the code on a computer readable medium; and
providing the program code to be deployed and executed on a computer system, the program code comprising instructions which, when executed on the computer system, cause the computer system to:
categorize a plurality of business objectives and principles indicative of a service-oriented architecture enterprise with respect to a plurality of business objectives and principles categories;
define groupings of individual measurable business goals of the business objectives and principles categorized with respect to each of the plurality of business objectives and principles categories;
determine total weight values for each of the business goals as a product of an individual weighting value of the each business goal and a base weighting of the business objectives and principles category of the each business goal;
iteratively apply each of the business goal total weight values to each of a plurality of priority values of a service of the service-oriented architecture associated with the business goal of the each business goal total weight value to generate a weighted priority value for the each business goal until weighted priority values are generated for all of the plurality of service priority values;
aggregate the weighted business goal priority values to produce an aggregated priority weighting value for the service; and
prioritize the service relative to another service as a function of comparing the aggregated priority weighting value for the service to an aggregated priority weighting value for the another service.

13. The method of claim 12, the program code comprising instructions which, when executed on the computer system, causes the computer system to determine the total weight values for each of the business goals by:
apportioning category base weighting percentage values to each of the plurality of business objectives and principles categories;
apportioning individual intra-category weighting distribution values to each of the business goals as a function of the business objectives and principles categories; and
determining the total weight value for each of the business goals as a product of the individual intra-category weighting distribution value of the each business goal and the category base weighting of the business objectives and principles category of the each business goal.

14. The method of claim 13, the program code comprising instructions which, when executed on the computer system, causes the computer system to:
apportion the category base weighting percentage values by apportioning each of a set of category base weighting percentage values totaling 100% in value; and
apportion the individual intra-category weighting distribution values by apportioning each of a set of individual intra-category base weighting distribution values totaling 100% in value;
wherein a total of all of the total weight values equals 100%.

15. The method of claim 14, the program code comprising instructions which, when executed on the computer system, causes the computer system to:
categorize the service with respect to one of a plurality of business programs;
categorize the service with respect to one of a plurality of specific enterprise domains as a function of an aspect of the service; and
prioritize the service relative to the another service is a function of the categorized business program and the categorized domain of the service and of a categorized business program and a categorized domain of the another service.

16. The method of claim 15, the program code comprising instructions which, when executed on the computer system, causes the computer system to:
populate the each priority value of the service associated with the each business goal with an initial default value selected from an integer value from a scale of values; and
adjust the initial default value as a function of comparing current organization observation data to historical organization observation data.

17. A programmable device comprising:
a processing means;
a memory in communication with the processing means comprising a logic component; and
a network interface in communication with the processing means and the memory;
wherein the processing means is configured by the logic component to:
categorize a plurality of business objectives and principles indicative of a service-oriented architecture enterprise with respect to a plurality of business objectives and principles categories;
define groupings of individual measurable business goals of the business objectives and principles categorized with respect to each of the plurality of business objectives and principles categories;
determine total weight values for each of the business goals as a product of an individual weighting value of the each business goal and a base weighting of the business objectives and principles category of the each business goal;
iteratively apply each of the business goal total weight values to each of a plurality of priority values of a service of the service-oriented architecture associated with the business goal of the each business goal total weight value to generate a weighted priority value for the each business goal until weighted priority values are generated for all of the plurality of service priority values;
aggregate the weighted business goal priority values to produce an aggregated priority weighting value for the service; and
prioritize the service relative to another service as a function of comparing the aggregated priority weighting value for the service to an aggregated priority weighting value for the another service.

18. The programmable device of claim 17, wherein the processing means is further configured to determine the total weight values for each of the business goals by:
apportioning category base weighting percentage values to each of the plurality of business objectives and principles categories;
apportioning individual intra-category weighting distribution values to each of the business goals as a function of the business objectives and principles categories; and
determining the total weight value for each of the business goals as a product of the individual intra-category weighting distribution value of the each business goal and the category base weighting of the business objectives and principles category of the each business goal.

19. The programmable device of claim 18, wherein the processing means is further configured to:
apportion the category base weighting percentage values by apportioning each of a set of category base weighting percentage values totaling 100% in value; and
apportion the individual intra-category weighting distribution values by apportioning each of a set of individual intra-category base weighting distribution values totaling 100% in value;
wherein a total of all of the total weight values equals 100%.

20. The programmable device of claim 19, wherein the processing means is further configured to:
categorize the service with respect to one of a plurality of business programs;
categorize the service with respect to one of a plurality of specific enterprise domains as a function of an aspect of the service; and
prioritize the service relative to the another service is a function of the categorized business program and the categorized domain of the service and of a categorized business program and a categorized domain of the another service.
